(19) United States
(12) Patent Application Publication
(10) Pub. No.: US 2024/0127350 A1
(43) Pub. Date: Apr. 18, 2024

(54) INFORMATION PROCESSING APPARATUS, INFORMATION PROCESSING METHOD, INFORMATION PROCESSING SYSTEM, AND COMPUTER READABLE MEDIUM

(71) Applicant: NEC Corporation, Minato-ku, Tokyo (JP)

(72) Inventors: Tetsuro Hasegawa, Tokyo (JP); Hiroaki Aminaka, Tokyo (JP); Kazuki Ogata, Tokyo (JP); Kei Yanagisawa, Tokyo (JP); Kosei Kobayashi, Tokyo (JP)

(73) Assignee: NEC Corporation, Minato-ku, Tokyo (JP)

(21) Appl. No.: 18/280,599

(22) PCT Filed: Mar. 10, 2021
(86) PCT No.: PCT/JP2021/009690

§ 371 Date: Sep. 6, 2023

(51) Int. Cl. G06Q 40/08; G07C 5/00

(52) U.S. Cl. CPC G06Q 40/08; G07C 5/008

(57) ABSTRACT

An information processing apparatus (10) includes: an acquisition means (11) for acquiring information based on a sensor that measures information regarding a road; a generation means (12) for generating information indicating an accident situation according to an insurer based on the information acquired by the acquisition means; and a transmission means (13) for transmitting the information indicating the accident situation generated by the generation means to an apparatus of the insurer.

### TECHNICAL FIELD

The present disclosure relates to an information processing apparatus, an information processing method, an information processing system, and a non-transitory computer readable medium storing a program.

### BACKGROUND ART

Patent Literature 1 discloses a technique for providing an insurance company with information such as the type of a traffic accident, the degree of damage of a vehicle, and the degree of injury of an occupant. Patent Literature 1 describes that the types of traffic accidents such as a minor accident and a frontal collision accident based on a traveling image captured by an exterior camera of a vehicle.

### CITATION LIST

### Patent Literature

Patent Literature 1: Japanese Unexamined Patent Application Publication No. 2020-091525

### SUMMARY OF INVENTION

### Technical Problem

However, the technology described in Patent Literature 1 has a problem that information regarding traffic accidents provided to an insurer may not be sufficient, for example. This is because the types of traffic accidents such as a minor accident and a frontal collision accident are analyzed based on the traveling image captured by an exterior camera of the vehicle.

In view of the above-described problem, an object of the present disclosure is to provide an information processing apparatus, an information processing method, an information processing system, and a non-transitory computer readable medium storing a program, for appropriately providing information regarding traffic accidents.

### Solution to Problem

In a first aspect according to the present disclosure, an information processing apparatus includes: an acquisition means for acquiring information based on a sensor that measures information regarding a road; a generation means for generating information indicating an accident situation according to an insurer based on the information acquired by the acquisition means; and a transmission means for transmitting the information indicating the accident situation generated by the generation means to an apparatus of the insurer.

In a second aspect according to the present disclosure, an information processing apparatus acquires information based on a sensor that measures information regarding a road, generates information indicating an accident situation according to an insurer based on the acquired information, and transmits the generated information indicating the accident situation to an apparatus of the insurer.

In a third aspect according to the present disclosure, an information processing system includes an information processing apparatus, a base station, and an insurer apparatus, in which the base station transmits information based on a sensor that measures information regarding a road, and the information processing apparatus includes: an acquisition means for acquiring the information based on the sensor; a generation means for generating information indicating an accident situation according to an insurer based on the information acquired by the acquisition means; and a transmission means for transmitting the information indicating the accident situation generated by the generation means to an apparatus of the insurer.

In a fourth aspect according to the present disclosure, there is provided a non-transitory computer readable medium storing a program for causing an information processing apparatus to execute a process of acquiring information based on a sensor that measures information regarding a road, a process of generating information indicating an accident situation according to an insurer based on the acquired information, and a process of transmitting the generated information indicating the accident situation to an apparatus of the insurer.

### Advantageous Effects of Invention

According to one aspect, it is possible to appropriately provide information regarding a traffic accident.

### BRIEF DESCRIPTION OF DRAWINGS

FIG. 1 is a diagram illustrating a configuration example of an information processing system according to an example embodiment.

FIG. 2 is a diagram illustrating a hardware configuration example of a server, an insurer apparatus, a traffic information providing apparatus, a computer of a vehicle, a terminal, and a DB server according to the example embodiment.

FIG. 3 is a diagram illustrating an example of a configuration of the server according to the example embodiment.

FIG. 4 is a sequence diagram illustrating an example of a process of recording traffic information by the information processing system according to the example embodiment.

FIG. 5 is a diagram describing an example of information recorded in a traffic information DB according to the example embodiment.

FIG. 6 is a flowchart illustrating an example of a process of generating information indicating an accident situation in accordance with a pattern of a traffic accident according to the example embodiment.

FIG. 7 is a diagram describing an example of information recorded in a generation item DB according to the example embodiment.

### EXAMPLE EMBODIMENT

Hereinafter, example embodiments of the present invention will be described with reference to the drawings.

<System Configuration>

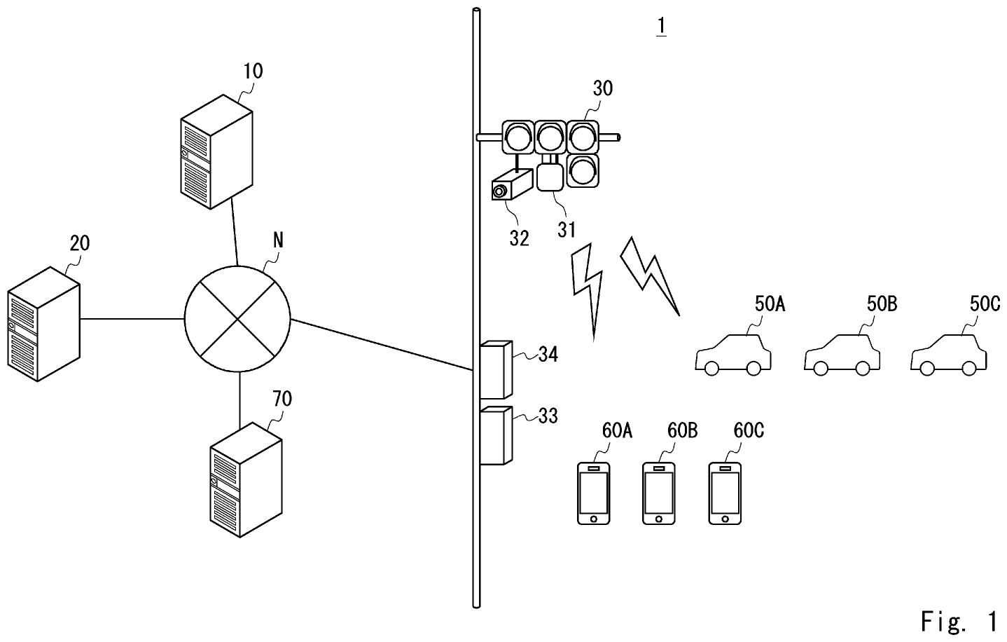

FIG. 1 is a diagram illustrating a configuration example of an information processing system 1 according to the example embodiment. Note that, although an example in which a traffic information providing apparatus 34 is attached to a pole (traffic light pole) to which a traffic light 30 is attached will be described below, the technology of the present disclosure is not limited thereto. For example, the traffic information providing apparatus 34 may be attached to a pole (for example, a pole to which a road sign or the like is attached, a street light, a utility pole, or the like) to which the traffic light 30 is not attached. In this case, the traffic light 30 and a signal control apparatus 33 are not provided, and the traffic light base station and the traffic light sensor are replaced with a “roadside base station”, a “roadside sensor”, and the like.

Referring to FIG. 1, the information processing system 1 includes a server 10, an insurer apparatus 20, a traffic light 30, a traffic light base station 31, a traffic light sensor 32, a signal control apparatus 33, and a traffic information providing apparatus 34. The information processing system 1 also includes a vehicle 50A, a vehicle 50B, and a vehicle 50C (hereinafter, simply referred to as “vehicles 50” in a case where there is no need to distinguish among them). The information processing system 1 includes terminals 60A, 60B, 60C, . . . (hereinafter, simply referred to as “terminals 60” in a case where there is no need to distinguish among them) and a database (DB) server 70. The numbers of the server(s) 10, the insurer apparatus(es) 20, the traffic light(s) 30, the traffic light base station(s) 31, the traffic light sensor(s) 32, the signal control apparatus(es) 33, the traffic information providing apparatus(es) 34, the vehicle(s) 50, the terminal(s) 60, and the DB server(s) 70 are not limited to those in the example of FIG. 1. The server 10 is an example of an “information processing apparatus”.

The server 10, the insurer apparatus 20, the traffic information providing apparatus 34, and the DB server 70 are connected such that they can communicate via a communication line N such as the Internet, a wireless local area network (LAN), or a mobile phone network, for example.

The traffic light 30, the traffic light base station 31, the traffic light sensor 32, the signal control apparatus 33, and the traffic information providing apparatus 34 are connected such that they can communicate by various signal cables or wireless communication.

The traffic light 30 is, for example, a traffic light that is installed on a traffic light pole of an intersection or the like of a road and controls traffic between vehicles 50 and pedestrians by displaying green, yellow, and red arrows, and the like. The traffic light 30 includes a traffic light for vehicles and a traffic light for pedestrians.

The traffic light base station 31 is a base station installed on a traffic light pole. It should be noted that, the term “base station” (BS) used in the present disclosure refers to a device that can provide or host a cell or coverage in which the vehicle 50 or the terminal 60 can wirelessly communicate.

Examples of the traffic light base station 31 include an NR Node B (gNB), a Node B (or NB), an Evolved Node B (eNodeB or eNB), and the like. Examples of the traffic light base station 31 include a remote radio unit (RRU), a radio head (RH), a remote radio head (RRH), a low power node (for example, femto node, pico node), and the like.

The wireless communication described in the present disclosure may conform to standards such as a 5th generation mobile communications system (5G, New Radio: NR), a 4th generation mobile communication system (4G), and a 3rd generation mobile communication system (3G). Note that 4G may include, for example, long term evolution (LTE) advanced, WiMAX2, and LTE. Furthermore, the wireless communication described in the present disclosure may conform to standards such as a wideband code division multiple access (W-CDMA), a code division multiple access (CDMA), a global system for mobile (GSM), and a wireless local area network (LAN). The wireless communication of the present disclosure may also be performed in accordance with any generation of wireless communication protocols now known or developed in the future.

The traffic light sensor 32 is various types of sensors installed on a traffic light pole and configured to measure various types of information regarding a road. The traffic light sensor 32 may be, for example, a sensor such as a camera, LiDAR (Light Detection and Ranging, Laser Imaging Detection and Ranging), RADAR (radio detection and Ranging) or the like. The traffic light sensor 32 may detect, for example, positions and speeds of the vehicle 50, a pedestrian, and the like.

The signal control apparatus 33 is installed on a traffic light pole and controls the traffic light 30. The signal control apparatus 33 controls display of red, green, yellow, and the like of the traffic light 30 based on, for example, a traffic condition detected by the traffic light sensor 32, an instruction from a center that manages traffic, preset data, or the like.

The traffic information providing apparatus 34 generates information (traffic information) regarding traffic around the traffic light 30 based on information acquired from the traffic light sensor 32, the signal control apparatus 33, and the like. The traffic information providing apparatus 34 then transmits (provides, notifies) the generated information to external devices such as the vehicle 50, the terminal 60, and the DB server 70 via the traffic light base station 31.

The vehicle 50 is a vehicle that travels on a road where the traffic light 30 is installed. The vehicle 50 performs wireless communication via the traffic light base station 31 by a wireless communication device mounted in the vehicle 50. Examples of the vehicle 50 include, but are not limited to, an automobile, a motorcycle, a motorized bicycle, and a bicycle.

The terminal 60 is a terminal that is carried by a user such as a pedestrian and performs wireless communication via the traffic light base station 31. Examples of the terminal 60 include, but are not limited to, a smartphone, user equipment (UE), a mobile phone, a cellular phone, a personal digital assistant (PDA), a portable computer, a game device, a music storage and music playback device, a wearable device, and the like.

The DB server 70 records traffic information received from the traffic information providing apparatus 34. The DB server 70 may be a server operated by a public institution, for example. The server 10 generates information indicating an accident situation according to a pattern (type) of a traffic accident based on the traffic information provided by the traffic information providing apparatus 34 and transmits the information to the insurer apparatus 20. The server 10 may be a server operated by a business partner with an insurer or a server operated by an insurer, for example. The insurer apparatus 20 is a device such as a server or a terminal of an insurer in which the user of the vehicle 50 subscribes to an insurance.

<Hardware Configuration>

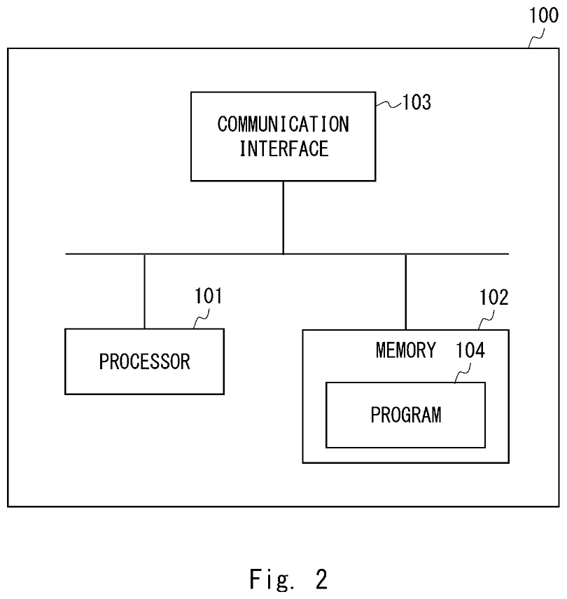

FIG. 2 is a diagram illustrating a hardware configuration example of the server 10, the insurer apparatus 20, the traffic information providing apparatus 34, the computer of the vehicle 50, the terminal 60, and the DB server 70 according to the example embodiment. The server 10 will be described below as an example. The hardware configurations of the insurer apparatus 20, the traffic information providing apparatus 34, the computer of the vehicle 50, the terminal 60, and the DB server 70 may be similar to the hardware configuration of the server 10 in FIG. 2.

In the example of FIG. 2, the server 10 (computer 100) includes a processor 101, a memory 102, and a communication interface 103. These units may be connected by a bus or the like. The memory 102 stores at least a part of the program 104. The communication interface 103 includes an interface necessary for communication with other network elements.

When the program 104 is executed by the processor 101, the memory 102, and the like in cooperation with each other, at least a part of the processing of the example embodiment of the present disclosure is performed by the computer 100. The memory 102 may be of any type suitable for a local technology network. The memory 102 may be a non-transitory computer-readable storage medium, as a non-limiting example. The memory 102 may also be implemented using any suitable data storage technology, such as semiconductor-based memory devices, magnetic memory devices and systems, optical memory devices and systems, fixed memory and removable memory, and the like. Although only one memory 102 is illustrated in the computer 100, there may be several physically different memory modules in the computer 100. The processor 101 may be of any type. The processor 101 may include one or more of a general purpose computer, a special purpose computer, a microprocessor, a digital signal processor (DSP), and a processor based on a multi-core processor architecture as a non-limiting example. The computer 100 may have multiple processors, such as an application specific integrated circuit chip that is temporally dependent on a clock that synchronizes the main processor.

Example embodiments of the present disclosure may be implemented in hardware or dedicated circuitry, software, logic, or any combination thereof. Some aspects may be implemented in hardware, while other aspects may be implemented in firmware or software that may be executed by a controller, microprocessor or other computing device.

The present disclosure also provides at least one computer program product tangibly stored on a non-transitory computer-readable storage medium. The computer program product includes computer-executable instructions, such as those included in a program module, and executes on a device on the subject real or virtual processor to perform the processes or methods of the present disclosure. Program modules include routines, programs, libraries, objects, classes, components, data structures, and the like that execute particular tasks or implement particular abstract data types. The functionality of the program modules may be combined or divided between the program modules as desired in various example embodiments. The machine-executable instructions of the program module can be executed in a local or distributed device. In a distributed device, program modules can be located on both local and remote storage media.

Program code for executing the methods of the present disclosure may be written in any combination of one or more programming languages. These program codes are provided to a processor or controller of a general purpose computer, special purpose computer, or other programmable data processing apparatus. When the program code is executed by a processor or controller, the functions/acts in the flowcharts and/or the implementing block diagrams are performed. The program code executes entirely on the machine, partly on the machine, as a stand-alone software package, partly on the machine, partly on a remote machine, or entirely on the remote machine or server.

The program can be stored and supplied to the computer using various types of non-transitory computer readable media. Non-transitory computer readable media include various types of tangible storage media. Examples of the non-transitory computer readable medium include a magnetic recording medium, a magneto-optical recording medium, an optical disc medium, a semiconductor memory, and the like. The magnetic recording medium includes, for example, a flexible disk, a magnetic tape, a hard disk drive, and the like. The magneto-optical recording medium includes, for example, a magneto-optical disk and the like. The optical disc medium includes, for example, a Blu-ray disc, a compact disc (CD)-read only memory (ROM), a CD-recordable (R), a CD-rewritable (RW), and the like. The semiconductor memory includes, for example, a mask ROM, a programmable ROM (PROM), an erasable PROM (EPROM), a flash ROM, a random access memory (RAM), and the like. Further, the program may be supplied to the computer using various types of transitory computer readable media. Examples of the transitory computer readable media include electrical signals, optical signals, and electromagnetic waves. The transitory computer readable media can provide the program to the computer via a wired communication line such as an electric wire and optical fibers or a wireless communication line.

<Configuration>

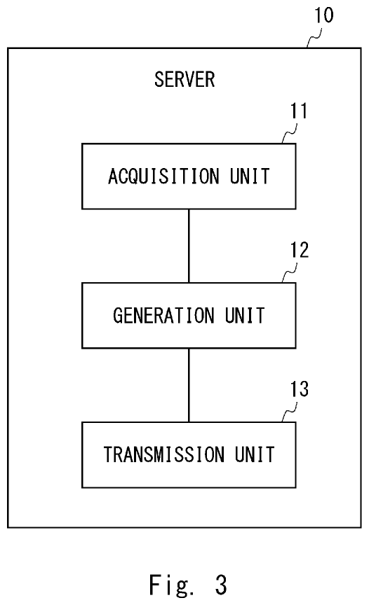

A configuration of the server 10 according to the example embodiment will be described with reference to FIG. 3. FIG. 3 is a diagram illustrating an example of a configuration of the server 10 according to the example embodiment. The server 10 includes an acquisition unit 11, a generation unit 12, and a transmission unit 13. These units may be implemented by cooperation of one or more programs installed in the server 10 and hardware such as a processor 101 and a memory 102 of the server 10.

The acquisition unit 11 acquires information based on the traffic light sensor 32 via the traffic light base station 31 and the DB server 70. The generation unit 12 generates information indicating an accident situation according to a pattern of a traffic accident based on the information acquired by the acquisition unit 11. The transmission unit 13 transmits the information indicating the accident situation generated by the generation unit 12 to the insurer apparatus 20.

<Processes>

<<Process of Recording Traffic Information>>

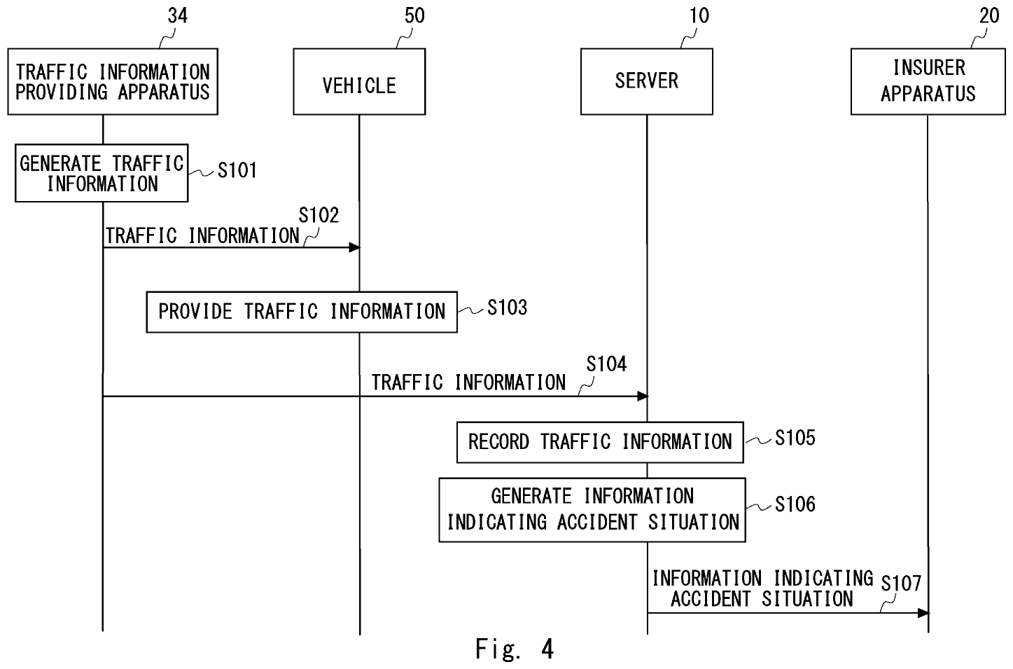

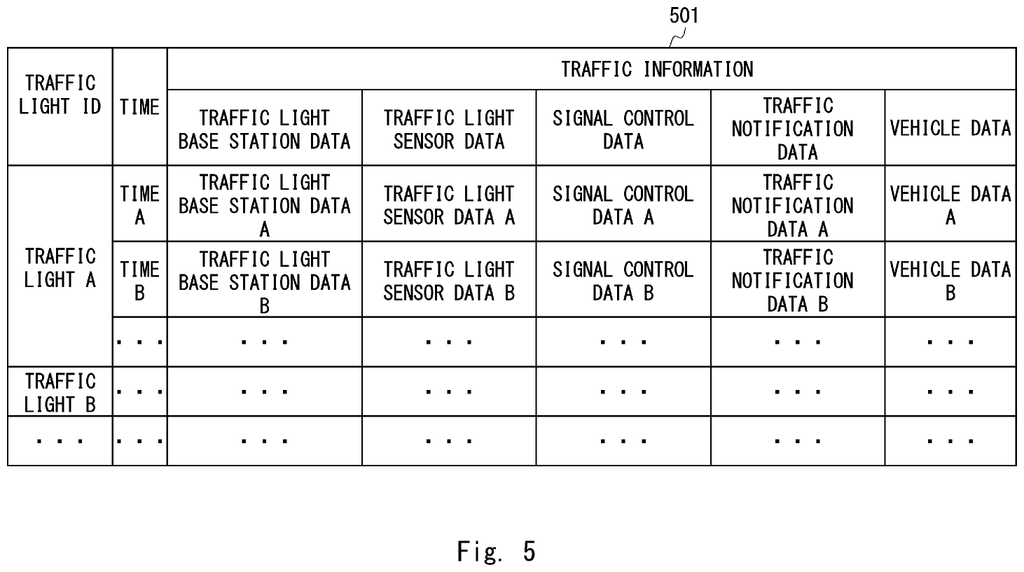

An example of a process of recording traffic information of the information processing system 1 according to the example embodiment will be described with reference to FIGS. 4 and 5. FIG. 4 is a sequence diagram illustrating an example of a process of recording traffic information by the information processing system 1 according to the example embodiment. FIG. 5 is a diagram describing an example of information recorded in a traffic information DB 701 according to the example embodiment.

In step S101, the traffic information providing apparatus 34 generates information (traffic information) regarding traffic around the traffic light 30 based on information acquired from the traffic light base station 31, the traffic light sensor 32, the signal control apparatus 33, the vehicle 50, and the like. Subsequently, the traffic information providing apparatus 34 provides at least part of the traffic information to the vehicle 50 and the like via the traffic light base station 31 (step S102). Herein, if there is an obstacle such as a depression in road or a fallen object on the road, for example, the traffic information providing apparatus 34 may provide the vehicle 50 with information indicating the position and size of the obstacle.

The traffic information providing apparatus 34 may provide the vehicle 50 with information (hereinafter, also referred to as “blind spot information” as appropriate) regarding an object at a position that is a blind spot for each vehicle 50 (hereinafter, also simply referred to as a “blind spot position” as appropriate), for example. The blind spot position may include a position that becomes a blind spot as viewed from the user of the vehicle 50 due to a wall, a vehicle waiting for right turn on the opposite lane, an oncoming vehicle, a following vehicle, and the like, for example. The blind spot information may include an image in which a blind spot position is captured (moving image or still image), the position and speed of an object at the blind spot position (for example, a pedestrian or another vehicle), and the like, for example. In a case where an object such as a pedestrian or another vehicle is present at a blind spot position of the vehicle 50, the traffic information providing apparatus 34 may provide the vehicle 50 with information indicating the presence (warning regarding the blind spot position).

The traffic information providing apparatus 34 may provide the vehicle 50 with information on the indication of traffic signal of the traffic light 30 and information on the remaining time until the traffic signal is changed, for example. Similarly, the traffic information providing apparatus 34 may provide the terminal 60 of the pedestrian with at least a part of the traffic information.

Subsequently, the vehicle 50 provides the user of the vehicle 50 with the provided traffic information (step S103). Herein, the vehicle 50 may provide the traffic information by display on a car navigation screen or the like and sound, for example.

Subsequently, the acquisition unit 11 of the server 10 acquires at least part of the traffic information generated by the traffic information providing apparatus 34 via the traffic light base station 31 (step S104). Herein, the server 10 may acquire the traffic information via the DB server 70, for example. The server 10 may acquire the traffic information from the traffic information providing apparatus 34 without passing through the DB server 70.

Subsequently, the generation unit 12 of the server 10 records the received traffic information in a traffic information DB 501 of the server 10 (step S105). In the example of FIG. 5, the traffic information is recorded in the traffic information DB 501 in association with a traffic light ID and time. The traffic light ID is identification information of the traffic light 30. The time is a time related to the traffic information. The time may be a time when the traffic information was generated by the traffic information providing apparatus 34, for example. The traffic information includes traffic light base station data, traffic light sensor data, signal control data, traffic notification data, and vehicle data.

The traffic light base station data is information acquired from the traffic light base station 31. The traffic light base station data includes identification information and position information of each device (for example, the vehicle 50 and the terminal 60) located (position registered) in the traffic light base station 31, for example. The traffic light base station 31 may acquire information on the current position of each device from each device, for example. In this case, the devices such as the vehicle 50 and the terminal 60 may measure the current position using a satellite positioning system such as a global positioning system/global positioning satellite (GPS). The devices such as the vehicle 50 and the terminal 60 may measure the current position based on radio wave received from the traffic light base station 31.

The traffic light sensor data is information generated based on the traffic light sensor 32. The traffic light sensor data may include various types of information measured by the traffic light sensor 32 based on an image or the like, for example.

The traffic light sensor data may include information on a traffic volume (for example, the number of vehicles 50 that have passed per unit time) in each lane of a road on which the traffic light 30 performs traffic control (hereinafter, also simply referred to as “road” as appropriate), and a traffic volume in each traveling direction of the road, for example. The traffic light sensor data may include information on the number of vehicles 50 waiting to turn right on a road, the type of each vehicle 50 that has passed through the road (for example, the vehicle type such as an automobile), the speed and acceleration of each vehicle 50 in each lane in which the vehicle 50 has passed through the road and in each traveling direction, for example.

The traffic light sensor data may include information on the position, traveling direction, speed, and vehicle registration number of a license plate of each vehicle 50 that is traveling on a road, for example. The traffic light sensor data may include information on the number of vehicles 50 waiting for a traffic signal (vehicles 50 waiting for the traffic signal to turn green) and the queue length of the vehicles 50 waiting for a traffic signal in each lane of the road, for example. The traffic light sensor data may include information on the number of pedestrians waiting to cross a road, the number of pedestrians crossing the road, and the speed of each pedestrian crossing the road, for example.

The traffic light sensor data may include information indicating the position and size of an obstacle such as a depression in a road and a fallen object on the road, for example. The traffic light sensor data may include a moving image captured by the camera of the traffic light sensor 32, for example. The traffic light sensor data may include information on a rainfall amount and a snowfall amount measured by a weather sensor of the traffic light sensor 32, for example.

The signal control data is information acquired from the signal control apparatus 33, and may include the indication of a signal, information on the remaining time until the signal is changed, and the like, for example.

The traffic notification data is information indicating traffic information provided by the traffic information providing apparatus 34 to the vehicle 50 and the like. The traffic notification data may include notification contents and information indicating whether the notification has succeeded. The traffic information providing apparatus 34 may determine that the notification has succeeded if, after the provision of the traffic information to the vehicle 50 or the like in step S102, the traffic information providing apparatus 34 has received an acknowledgement response of receipt from the vehicle 50 or the like.

The vehicle data is various types of data regarding each vehicle 50 acquired from the vehicle 50 via the traffic light base station 31 or the like, for example. The vehicle data may include identification information of the vehicle 50, information indicating the version of a program for automatic driving of the vehicle 50, information indicating the driving mode of the vehicle 50, and the like, for example. In this case, the driving mode of the vehicle 50 may include information indicating whether the vehicle 50 is currently performing automatic driving or is manually being driven by the user, for example. The driving mode of the vehicle 50 may include information on the time when the vehicle 50 requested the user to intervene (switched to manual driving). The driving mode of the vehicle 50 may include information indicating whether the function of providing the blind spot information has been activated.

The information indicating whether the function of providing the blind spot information has been activated may include information indicating whether a display screen of an application for providing the blind spot information is set to be displayed on a display device (display of a car navigation device) of the vehicle 50, for example. In this case, in a case where the car navigation screen is set to be displayed, the vehicle 50 may transmit information indicating that the function of providing the blind spot information has been activated to the traffic light base station 31 or the like. In a case where the display screen of television broadcasting, DVD, or the like is set to be displayed, the vehicle 50 may transmit information indicating that the function of providing the blind spot information has not been activated to the traffic light base station 31 or the like.

The vehicle 50 may transmit the vehicle data to the traffic information providing apparatus 34 via the traffic light base station 31 when the vehicle 50 becomes located (position registered) in the cell of the traffic light base station 31. The vehicle 50 may transmit the vehicle data to the traffic information providing apparatus 34 via the traffic light base station 31 at a predetermined timing such as periodically while the vehicle is located in the cell of the traffic light base station 31. The vehicle 50 may transmit the vehicle data to the traffic information providing apparatus 34 via the traffic light base station 31 when an acceleration sensor or the like has detected an impact equal to or greater than a threshold.

Subsequently, the generation unit 12 of the server 10 generates information indicating an accident situation according to the insurer as the information provision destination based on the information recorded in the traffic information DB 501 or the like (step S106). Herein, the pattern of the traffic accident may include vehicle-to-vehicle, vehicle-to-bicycle, vehicle-to-pedestrian, and the like, for example. The server 10 may generate the information indicating the accident situation in a data format such as a JavaScript (registered trademark) Object Notation (JSON) format or a key-value format, for example.

Subsequently, the transmission unit 13 of the server 10 transmits the information indicating the accident situation to the insurer apparatus 20 of the insurer as the information provision destination (step S107). Accordingly, the insurer can create a report of the traffic accident involving the user of the vehicle 50 who is an insurant. The insurer can also estimate the percentage of fault or the like of the user of the vehicle 50 in the traffic accident.

<<Process of Generating Information Indicating Accident Situation According to Insurer as Information Provision Destination>>

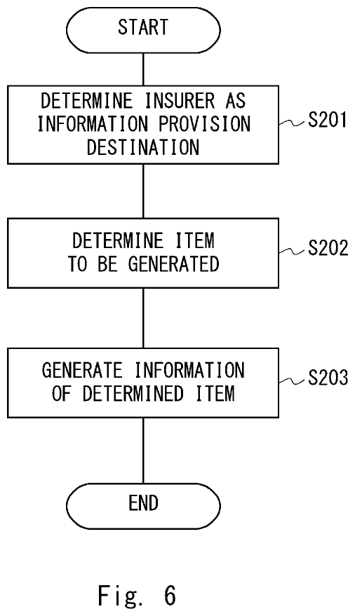

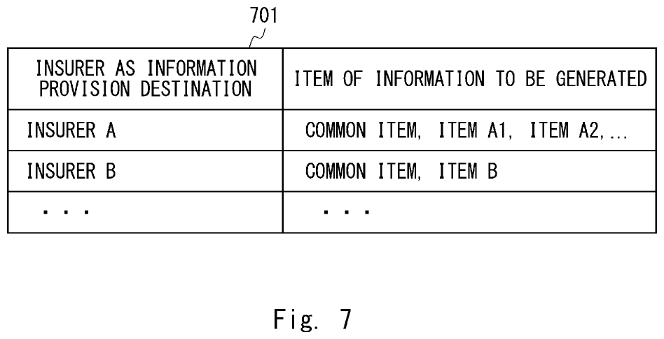

Next, an example of a process of generating information indicating an accident situation according to the insurer as the information provision destination in step S106 of FIG. 4 will be described with reference to FIGS. 6 and 7. FIG. 6 is a flowchart illustrating an example of a process of generating information indicating an accident situation in accordance with the insurer as the information provision destination according to the example embodiment. FIG. 7 is a diagram describing an example of information recorded in a generation item DB 701 according to the example embodiment.

In step S201, the server 10 determines the insurer as the information provision destination of a traffic accident involving the vehicle 50. Herein, the server 10 may determine the insurer as the information provision destination based on a request from the insurer, for example. In this case, the server 10 may receive, from the insurer apparatus 20, an information provision request including information regarding the traffic accident input based on hearings from the user or the like of the vehicle 50 by the operator or the like of the insurer. In this case, the information regarding the traffic accident may include information indicating the time and place at which the traffic accident occurred (for example, the name or the like of the intersection where the traffic light 30 is installed), and information indicating the vehicle 50 involved in the traffic accident, for example. The information indicating the vehicle 50 involved in the traffic accident may include information such as the color, vehicle type, and vehicle registration number of the license plate of the vehicle 50, for example.

The server 10 may further recognize the vehicle registration number or the like of the license plate of the vehicle 50 involved in the traffic accident based on an image or the like measured by the traffic light sensor 32, for example. Then, the server 10 may specify the insurer to which the user of the vehicle 50 subscribes based on the recognized vehicle registration number. In this case, the server 10 may have information in which vehicle registration numbers and insurers are associated with each other registered in advance.

Subsequently, the server 10 determines an item of information to be generated (item to be generated) according to the insurer to which the information on the traffic accident is provided, based on the generation item DB 701 (step S202). Herein, the server 10 may determine an item designated by the insurer as the information provision destination, as an item to be generated, for example. In this case, the server 10 may receive information indicating the item to be generated from the insurer apparatus 20. The server 10 may set the item to be generated in advance from the insurer as the information provision destination.

In the example of FIG. 7, one or more items of information to be generated are recorded in the generation item DB 701 in association with the insurers to which the information on traffic accidents is provided. In the example of FIG. 7, in a case of providing information indicating an accident situation to insurer A, the server 10 determines a common item, item A1, item A2, and the like as items of information to be generated. The common item is an item in common among the insurers. The common item may include information indicating time and place of occurrence of a traffic accident, a moving image captured by the traffic light sensor 32 at the occurrence of the traffic accident, and the like, for example.

Subsequently, the server 10 generates information of the item determined in step S202 based on the traffic information provided from the traffic information providing apparatus 34 (step S203). In a case where the insurer as the information provision destination is a business operator that controls driving of the vehicle involved in the traffic accident by cloud computing or the like via the traffic light base station 31, the server 10 may determine information indicating a processing load of the traffic light base station 31 at the time of occurrence of the traffic accident, as an item to be generated. Accordingly, in a case where the processing load of the traffic light base station 31 is abnormally large, the insurer can further investigate and examine the degree of delay of a control command to the vehicle 50 to estimate the percentage of fault of the user of the vehicle 50, for example.

The server 10 may determine the item to be generated based on the coverage of the insurance contract between the user of the vehicle 50 involved in the traffic accident and the insurer, for example. In this case, the server 10 may receive information indicating the coverage of the insurance contract between the user and the insurer from the insurer apparatus 20. The server 10 may have information indicating the coverage of the insurance contract between the user and the insurer set in advance from the insurer as the information provision destination.

The server 10 may determine whether the coverage of the insurance contract of the user is the contract coverage under which the user can receive preferential treatment for an insurance premiums in a case of a traffic accident that has occurred during automatic driving (for example, automatic driving of level 3 or higher) of the vehicle 50 of the user. Then, in the case of such contract coverage, the server 10 may determine information indicating whether the vehicle 50 was in automatic driving at the occurrence of the traffic accident as an item to be generated. Accordingly, in a case of a traffic accident during automatic driving of the vehicle 50 of the user, the insurer can prevent downgrading of a grade (non-fleet grade) for applying a discount and an addition of the insurance premium according to an insurance claim history of traffic accidents, for example. In the case of such contract coverage, the server 10 may determine information related to the time when the vehicle 50 requested the user to intervene (switch to manual driving), as an item to be generated. Accordingly, the insurer can prevent downgrading of the non-fleet grade also in a case where the vehicle 50 of the user was performing automatic driving and the traffic accident has occurred within a predetermined time (for example, three seconds) after the user was requested to switch to manual driving, for example.

The server 10 may determine whether the coverage of the insurance contract of the user is the contract coverage under which the user can receive preferential treatment for an insurance premium in a case of a traffic accident that has occurred when the user was using the function of broadcasting the blind spot information transmitted from the traffic light base station 31. Then, in the case of such contract coverage, the server 10 may determine information indicating whether the function of the vehicle 50 has been activated as an item to be generated. Accordingly, in the case of a traffic accident that has occurred when the vehicle 50 of the user was using the function of providing the blind spot information, the insurer can prevent downgrading of the non-fleet grade, for example.

<Modified Examples>

Each functional unit (for example, the generation unit 12) of the server 10 may be implemented by cloud computing including one or more computers, for example. The server 10 and the DB server 70 may be configured as an integrated server. The server 10 and the insurer apparatus 20 may be configured as an integrated server. The server 10 and the traffic information providing apparatus 34 may be configured as an integrated server (apparatus).

The present invention is not limited to the above example embodiments, and can be appropriately changed without departing from the scope of the present invention.

Some or all of the above-described example embodiments may be described as in the following Supplementary Notes, but are not limited to the following Supplementary Notes.

(Supplementary Note 1)

An information processing apparatus including:
an acquisition means for acquiring information based on a sensor that measures information regarding a road;
a generation means for generating information indicating an accident situation according to an insurer based on the information acquired by the acquisition means; and
a transmission means for transmitting the information indicating the accident situation generated by the generation means to an apparatus of the insurer.

(Supplementary Note 2)

The information processing apparatus according to Supplementary Note 1, wherein the generation means generates the information indicating the accident situation including information of an item designated by the insurer.

(Supplementary Note 3)

The information processing apparatus according to Supplementary Note 1 or 2, wherein, in a case where the insurer is a business operator that controls driving of a vehicle involved in a traffic accident via a base station installed in association with the sensor, the generation means includes information indicating a processing load of the base station at a time of occurrence of the traffic accident occurs in the information indicating the accident situation.

(Supplementary Note 4)

The information processing apparatus according to any one of Supplementary Notes 1 to 3, wherein the generation means generates the information indicating the accident situation based on the information acquired by the acquisition means and coverage of an insurance contract between a user of a vehicle involved in the traffic accident and the insurer.

(Supplementary Note 5)

The information processing apparatus according to Supplementary Note 4, wherein, in a case where the coverage of the insurance contract is a contract coverage under which the user is allowed to receive preferential treatment for an insurance premium in a case of a traffic accident that has occurred when the vehicle was in automatic driving, the generation means includes information indicating whether the vehicle was in automatic driving at the time of the traffic accident, in the information indicating the accident situation.

(Supplementary Note 6)

The information processing apparatus according to Supplementary Note 4 or 5, wherein, in a case where the coverage of the insurance contract is a contract coverage under which the user is allowed to receive preferential treatment for an insurance premium in a case of a traffic accident that has occurred when the vehicle was in automatic driving, the generation means includes at least one of pieces of information regarding a time when the vehicle requested the user to intervene, in the information indicating the accident situation.

(Supplementary Note 7)

The information processing apparatus according to any one of Supplementary Notes 4 to 6, wherein, in a case where the coverage of the insurance contract is a contract coverage under which the user is allowed to receive preferential treatment for an insurance premium in a case of a traffic accident that has occurred when the user of the vehicle was using a function of providing information regarding information regarding an object at a position that was a blind spot of the vehicle, the generation means includes information indicating whether the vehicle has activated the function at the time of the traffic accident, in the information indicating the accident situation.

(Supplementary Note 8)

An information processing method including:
acquiring, by an information processing apparatus, information based on a sensor that measures information regarding a road;
generating, by the information processing apparatus, information indicating an accident situation according to an insurer based on the acquired information; and
transmitting, by an information processing apparatus, the generated information indicating the accident situation to an apparatus of the insurer.

(Supplementary Note 9)

An information processing system including an information processing apparatus, a base station, and an insurer apparatus, wherein
the base station transmits information based on a sensor that measures information regarding a road, and
the information processing apparatus includes:
an acquisition means for acquiring the information based on the sensor;
a generation means for generating information indicating an accident situation according to an insurer based on the information acquired by the acquisition means; and
a transmission means for transmitting the information indicating the accident situation generated by the generation means to an apparatus of the insurer.

(Supplementary Note 10)

The information processing system according to Supplementary Note 9, wherein the generation means generates the information indicating the accident situation including information of an item designated by the insurer.

(Supplementary Note 11)

A non-transitory computer readable medium storing a program for causing an information processing apparatus to execute:
a process of acquiring information based on a sensor that measures information regarding a road;
a process of generating information indicating an accident situation according to an insurer based on the acquired information; and
a process of transmitting the generated information indicating the accident situation to an apparatus of the insurer.

### REFERENCE SIGNS LIST

1 INFORMATION PROCESSING SYSTEM
10 SERVER
11 ACQUISITION UNIT
12 GENERATION UNIT
13 TRANSMISSION UNIT
20 INSURER APPARATUS
30 TRAFFIC LIGHT
31 TRAFFIC LIGHT BASE STATION
32 TRAFFIC LIGHT SENSOR
33 SIGNAL CONTROL APPARATUS
34 TRAFFIC INFORMATION PROVIDING APPARATUS
50 VEHICLE
60 TERMINAL

What is claimed is:

1. An information processing apparatus comprising:
at least one memory storing instructions, and
at least one processor configured to execute the instructions to;
acquire information based on a sensor that measures information regarding a road;
generate information indicating an accident situation according to an insurer based on the acquired information; and
transmit the generated information indicating the accident situation to an apparatus of the insurer.

2. The information processing apparatus according to claim 1, wherein the at least one processor is configured to execute the instructions to generate the information indicating the accident situation including information of an item designated by the insurer.

3. The information processing apparatus according to claim 1, wherein, in a case where the insurer is a business operator that controls driving of a vehicle involved in a traffic accident via a base station installed in association with the sensor, the at least one processor is configured to execute the instructions to generate information indicating a processing load of the base station at a time of occurrence of the traffic accident occurs in the information indicating the accident situation.

4. The information processing apparatus according to claim 1, wherein the at least one processor is configured to execute the instructions to generate the information indicating the accident situation based on the acquired information and coverage of an insurance contract between a user of a vehicle involved in the traffic accident and the insurer.

5. The information processing apparatus according to claim 4, wherein, in a case where the coverage of the insurance contract is a contract coverage under which the user is allowed to receive preferential treatment for an insurance premium in a case of a traffic accident that has occurred when the vehicle was in automatic driving, the at least one processor is configured to execute the instructions to generate information indicating whether the vehicle was in automatic driving at the time of the traffic accident, in the information indicating the accident situation.

6. The information processing apparatus according to claim 4, wherein, in a case where the coverage of the insurance contract is a contract coverage under which the user is allowed to receive preferential treatment for an insurance premium in a case of a traffic accident that has occurred when the vehicle was in automatic driving, the at least one processor is configured to execute the instructions to generate includes at least one of pieces of information regarding a time when the vehicle requested the user to intervene, in the information indicating the accident situation.

7. The information processing apparatus according to claim 4, wherein, in a case where the coverage of the insurance contract is a contract coverage under which the user is allowed to receive preferential treatment for an insurance premium in a case of a traffic accident that has occurred when the user of the vehicle was using a function of providing information regarding an object at a position that was a blind spot of the vehicle, the at least one processor is configured to execute the instructions to generate information indicating whether the vehicle has activated the function at the time of the traffic accident, in the information indicating the accident situation.

8. An information processing method comprising:
acquiring, by an information processing apparatus, information based on a sensor that measures information regarding a road;
generating, by the information processing apparatus, information indicating an accident situation according to an insurer based on the acquired information; and
transmitting, by an information processing apparatus, the generated information indicating the accident situation to an apparatus of the insurer.

9. An information processing system comprising an information processing apparatus, a base station, and an insurer apparatus, wherein
the base station transmits information based on a sensor that measures information regarding a road, and
the information processing apparatus includes:
at least one memory storing instructions, and
at least one processor configured to execute the instructions to;
acquire the information based on the sensor;
generate information indicating an accident situation according to an insurer based on the acquired information; and
transmit the generated information indicating the accident situation to an apparatus of the insurer.

10. The information processing system according to claim 9, wherein the at least one processor is configured to execute the instructions to generate the information indicating the accident situation including information of an item designated by the insurer.

11. (canceled)
